(19) United States
(12) Patent Application Publication
(10) Pub. No.: US 2004/0039876 A1
(43) Pub. Date: Feb. 26, 2004

(54) Portable mass memory device with memory card reader

(76) Inventors: James R. Nelson, Boise, ID (US); James P. Terry, Garden Valley, ID (US); James R. Smithers, Caldwell, ID (US)

Correspondence Address: HWELETT-PACKARD COMPANY, Intellectual Property Administration, P.O. Box 272400, Fort Collins, CO, 80527-2400, US

(21) Appl. No.: 10/224,917

(22) Filed: Aug. 21, 2002

(51) Int. Cl. G06F 12/00

(52) U.S. Cl. 711/115

(57) ABSTRACT

A portable mass memory device includes a housing and a mass memory device supported within the housing. The housing defines a memory card receptacle which can receive a compact moveable memory card. The device further includes a processor and a data access program which can be executed by the processor to enable transfer of data from a compact moveable memory card placed in the memory card receptacle to the mass memory.

### FIELD OF THE INVENTION

The invention claimed and disclosed herein pertains to portable mass memory devices, as for example a portable hard disk drive.

### BACKGROUND OF THE INVENTION

Memory cards, or more accurately descriptive, compact moveable semiconductor memory cards, are well established digital memory devices used in a large number of applications, and allow data to be easily moved from place-to-place. Common applications for memory cards (MCs) include: use in digital still cameras; use in digital video cameras; use in MP3 music players; use in personal digital assistants (PDAs); use in digital voice recorders; and use in digital video games. Other uses are known, and undoubtedly future applications will be implemented for use of these MCs. MCs come in a variety of shapes and sizes (as will be more fully described below), and generally have storage capabilities of between 32 MB and 512 MB of data. Obviously, increased storage capacity will become available as semiconductor memory chip technology advances.

FIG. 1 depicts one exemplary use of a memory card (MC). A digital still camera 32 is provided with a memory card slot 34, which is configured to receive a MC 30 (depicted here as a “Memory Stick®”). (“Memory Stick” is a registered trademark of Sony Kabushiki Kaisha TA Sony Corporation.) Digital pictures (images) recorded by the camera 32 can be stored on the MC 30. At some point a user of the digital camera 32 will desire to transfer the digital images stored on the MC, either due to the fact that the MC no longer has available storage capacity, or because the user wishes to access the images recorded on the MC 30. At this point the user removes the MC 30 from the MC slot 34 and places the MC into a slot 28 in an MC reader 26. The MC reader 26 is typically connectable to a computer system 10 via a cable 24, which connects to a universal serial buss (“USB”) connector 22. The USB allows a processor 18, housed in the main computer housing 16, to be transferred to a mass memory device, such as hard drive 20. However, data can also be transferred from the MC reader 26 to the computer system 10 using a wireless data transfer protocol, such as the Bluetooth® short range wireless communication protocol. (Bluetooth is a trademark of Telefonaktiebolaget LM Ericsson CORPORATION SWEDEN.) Once the images from the MC 30 have been stored on the hard drive memory 20, a user can view them on a monitor 12, or can further manipulate the images via a user input console, such as keyboard 14. (It will be appreciated that most computer systems, such as system 10, are provided with programs that allow digital files transferred from the MC 30 to be edited.) After the files from the MC 30 have been copied to the hard disk drive 20, the user can then delete the image files from the MC 30 to make room for new files to be stored on the MC.

Once the data storage capacity of the MC has been achieved when the MC is in the remote device (such as in digital camera 32), the user has four options: (1) cease using the remote device (e.g., stop taking pictures with the camera 32); (2) delete files stored on the MC; (3) replace the current MC with another MC having available storage capacity; or (4) transfer the data stored on the MC to a computer system (10) to make room for new files. If a user does not have ready access to a computer system, then the user is faced with exercising options 1, 2 or 3. Options 1 and 2 are typically undesirable (for obvious reasons). Option 3 (inserting another MC into the device) requires that the user have more than one MC on hand. Since MCs are relatively expensive devices, users are typically reluctant to purchase more than one MC. For example, if a user is recording digital video images on an MC while on vacation away from his or her personal computer, then the user may be required to carry several MCs in order to store all of the recorded video images the user desires to save.

What is needed then is a way to allow data from an MC to be transferred from the MC to a mass memory device, without requiring that a user of the MC have direct access to a computer system to facilitate transfer of the data.

### SUMMARY OF THE INVENTION

One embodiment of the present invention provides for a portable mass memory device having a housing and a mass memory device supported within the housing. The housing defines a memory card receptacle which can receive a compact moveable memory card. The device further includes a processor and a data access program which can be executed by the processor to enable transfer of digital data from a compact moveable memory card placed in the memory card receptacle to the mass memory. In one example the mass memory is a hard disk drive.

Yet another embodiment of the present invention provides for a portable mass memory device having a housing and a mass memory supported within the housing. A plurality of memory card contact sets are supported by the housing, each memory card contact set configured to interface with a respective contact set of a corresponding compact moveable memory card. The device further includes a processor, and a data access program which is executable by the processor to thereby enable the transfer of digital data from a compact moveable memory card placed in contact with at least one of the memory card contact sets to the mass memory.

These and other aspects and embodiments of the present invention will now be described in detail with reference to the accompanying drawings, wherein:

### DESCRIPTION OF THE DRAWINGS

FIG. 1 is a schematic diagram depicting a prior art system for transferring data from a memory card to a mass memory device using a computer system.

FIGS. 1A through 1C depict plan views of a variety of different types of prior art compact moveable semiconductor memory cards.

FIGS. 2A through 2C depict end views of the prior art compact moveable semiconductor memory cards depicted in corresponding FIGS. 1A through 1C.

FIGS. 3A and 3B are oblique diagrams depicting a portable mass memory device in accordance with one embodiment of the present invention.

FIG. 4 is an oblique diagram depicting a portable mass memory device in accordance with another embodiment of the present invention.

FIG. 5 is a side elevation, cross sectional diagram depicting a memory card adapter that can be used with the portable mass memory device depicted in FIG. 4.

FIG. 6 is a schematic diagram depicting one example of the components that can be used in the portable mass memory devices of FIGS. 3A and 4.

FIG. 7 is a block diagram depicting routines that can be provided in the data access program component of FIG. 6.

FIG. 8 is a menu map depicting an exemplary hierarchical user menu than can be provided for the user menu displays component of FIG. 7.

FIG. 9 is a rear view depicting a portable mass memory device in accordance with yet another embodiment of the present invention.

FIG. 10 is a rear view depicting a portable mass memory device in accordance with a further embodiment of the present invention.

FIG. 11 is a side elevation, sectional view of the portable mass memory device depicted in FIG. 10.

### DETAILED DESCRIPTION OF THE INVENTION

The present invention provides for a portable mass memory device which can receive a compact moveable memory card (“MC”). The portable mass memory device has a mass memory, such as a hard disk drive, and is configured to allow a user to transfer digital data from the MC to the mass memory. In this way a user can transfer files from an MC to a mass memory without having to take the MC to a computer having an MC reader. Since the portable mass memory device (PMMD) is relatively small in size, the user can carry both the PMMD and a device which uses the MC at the same time. As one example, a user taking photographs while traveling can carry a digital camera and the PMMD, and can thus transfer digital images from the MC to the PMMD. Once the user returns home, the user can transfer the digital images from the PMMD to a personal computer for printing, processing and/or archiving. Preferably, the PMMD also allows a user to transfer digital data from the mass memory in the PMMD to an MC. For example, a user can store a very large number of digital music files in the mass memory of the PMMD, and can then transfer selected files to an MC for use in an MP3 player.

Portable mass memory devices are known in the art, yet none of the currently available PMMDs are configured to receive an MC. One example of a prior art PMMD is the Archos Jukebox Studio 20 Recorder available from Archos S.A., Igny, France. The Archos Jukebox Studio 20 includes a 20 GB hard disk drive, and uses a USB port to allow data transfer between a personal computer and the hard disk drive. The Archos Jukebox Studio 20 can also function as an MP3 player, and can record data from an outside source (such as a digital tape player) directly to the hard disk drive via a “line-in” connection. The Archos Jukebox Studio 20 measures 114.5 mm (4.5 inches) in length by 83.8 mm (3.3 inches) in height, and 33 mm (1.3 inches) in width (or thickness). A PMMD is distinguishable over other mass memory devices in that the PMMD allows minimal, or no, file edit capabilities, other than file organization and deletion capabilities. Thus, a PMMD is distinguishable from the mass memory portions of a computer (including a laptop computer) since the PMMD does not allow a user to directly edit the files stored in the PMMD. While a PMMD can be connected to a computer to provide a user with file-edit capability, the PMD itself does not allow such functionality.

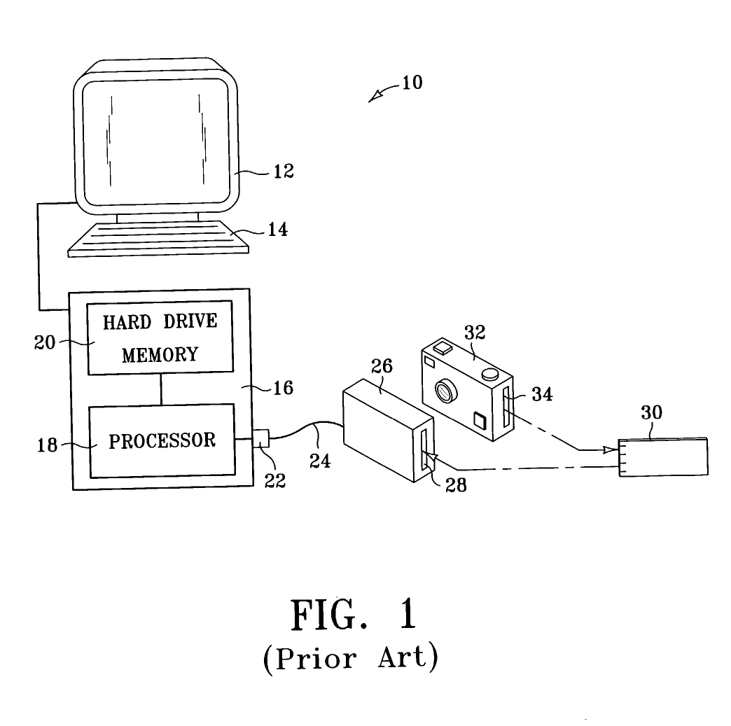

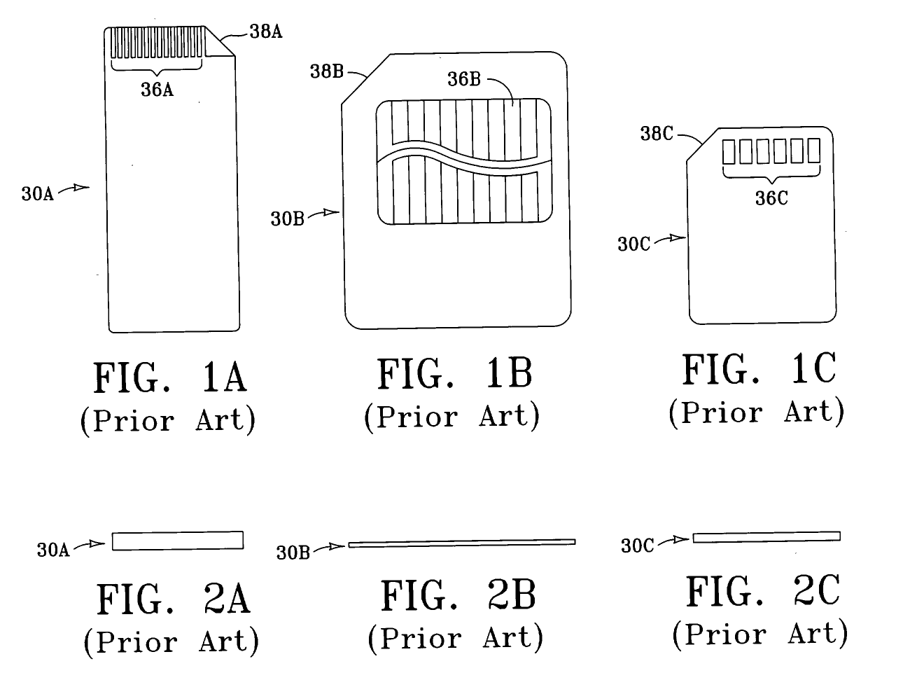

Memory cards currently are available in a variety of different configurations. FIGS. 1A through 1C depict plan views of four currently available types of MCs; FIGS. 2A through 2C depict end views the MCs corresponding to FIGS. 1A through 1C. FIGS. 1A and 2A depict an MC 30A known as a “Memory Stick®”, which is available from Sony Corporation, Shinagawa-ku, Tokyo, Japan. (“Memory Stick” is a registered trademark of Sony Kabushiki Kaisha TA Sony Corporation.) The Memory Stick® (“MS”) measures approximately 50 mm long by 21.45 mm wide by 2.8 mm thick. The MS 30A includes a contact set 36A which allows digital data to be transferred to and from the MS. The MS 30A further has a cut-corner 38A to facilitate alignment of the MS with a device configured to use the MS. FIGS. 1B and 2B depict respective plan and end views of an MC 30B known as a “SmartMedia Card”, or SMC, which is available from SanDisk Corporation, Sunnyvale, Calif., USA. The SMC 30B is also known as a “Solid State Floppy Disc Card, or “SSFDC”, and is a NAND-type small flash memory card measuring approximately 45 mm in length by 37 mm in width by 0.76 mm in thickness. The SMC 30B includes a contact set 36B which, as can be seen, is configured differently than the contact set 36A of the MS 30A of FIG. 1A. The SMC 30B also has a cut-corner 38B to facilitate alignment of the card in a device. FIGS. 1C and 2C depict respective plan and end views of an MC 30C which is known as a “MultiMediaCard”, or “MMC”, and which is available from SanDisk Corporation, Sunnyvale, Calif., USA. The MMC 30C measures 32 mm in length by 24 mm wide by 1.4 mm thick. The MMC 30C includes a contact set 36C which, as can be seen, is configured differently than the contact sets 36A and 36B of the MCs 30A and 30B of respective FIGS. 1A and 1B. The MMC 30C also has a cut-corner 38C to facilitate alignment of the card in a device.

In addition to the three exemplary MCs depicted in FIGS. 1A thorough 1C, other currently popular types of MCs include: (1) the CompactFlash (“CF”) memory card, which measures 36.4 mm by 42.8 mm by 3.3 mm; and (2) the Secure Digital Card, which allows data stored on the card to be encrypted for protection of the data. The Secure Digital Card is similar in dimensions to the MMC (30C of FIG. 1C), but is slightly thicker than the thickness of MC 30C depicted in FIG. 2C. It should be anticipated that some MC formats may become obsolete, and also that new MC formats may be introduced. Given the variety of MC formats currently in use, a portable mass memory device in accordance with the present invention is preferably configured to accommodate more than one MC format, as will be described more fully below.

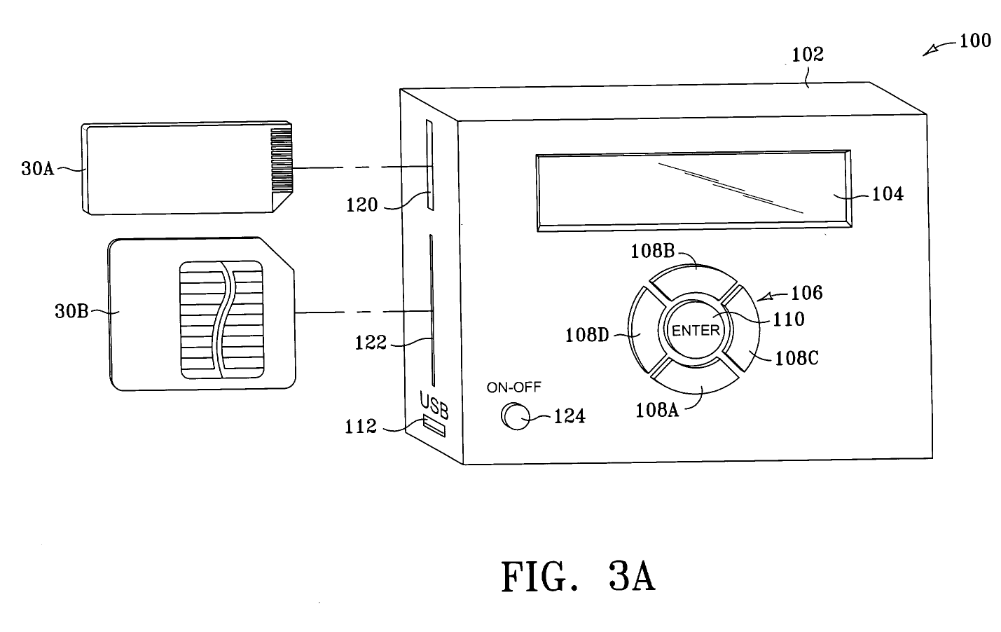

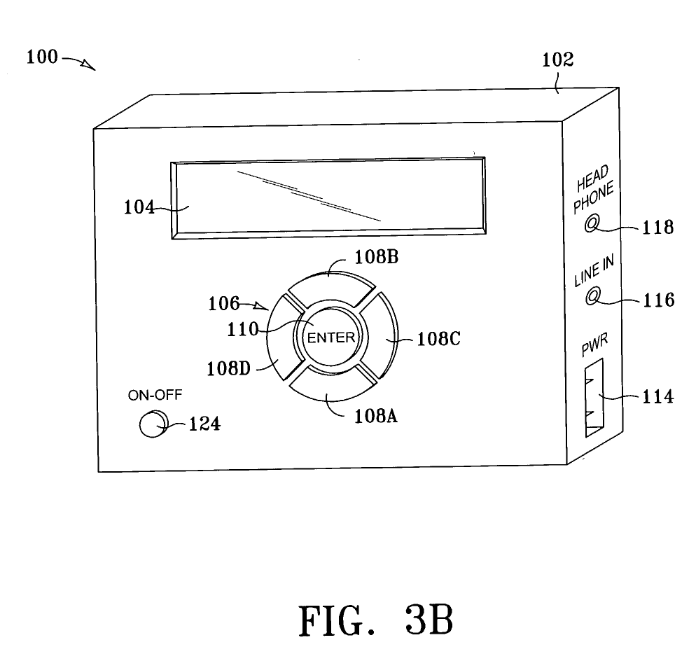

Turning now to FIG. 3A, an oblique diagram of a portable mass memory device (PMMD) 100 in accordance with the present invention is depicted. FIG. 3B is another oblique view of the PMMD 100 of FIG. 3A, but showing the right side of the PMMD. As can be seen in FIG. 3A, the PMMD 100 includes a housing 102. Housing 102 supports a read-write (or random access memory (“RAM”)) mass memory (not shown), such as a hard disk drive. (A PMMD which uses a hard disk drive as the mass memory is known as a “portable hard disk drive”.) It is anticipated that as semiconductor memory densities increase, due to further advances in semiconductor memory technology, future PMMDs can use semiconductor memory chips in lieu of a hard disk drive. The PMMD 100 includes a user display 104, such as a liquid crystal display (“LCD”), and a user input interface 106. The user input interface 106 includes four menu navigation buttons or input points 108A-108D, and an “Enter” button or input point 110 to allow a user to select a menu option. The use of the user input station 106 will be described more fully below. The PMMD 110 also includes a power switch 124.

Turning to FIG. 3B, the PMMD can include a power connection 114 to allow the PMMD to be run off of A/C power, or to recharge a battery in the PMMC. However, the primary power source for the PMMD will be a battery (not shown in this view). The PMMD 100 can optionally be provided with a “line-in” jack 116 to allow data to be transferred from an external source (such as a digital tape recorder) to the PMMD for storage on the mass memory. The PMMD 100 can further optionally be provided with a headphone jack 118 to allow a user to listen to audio files stored on the mass memory in the PMMD. The headphone jack can be more generically known as a “line-out” jack to allow digital data stored on the mass memory to be transferred to a user device in “real time”. For example, the line-out jack can be connected to a digital video camera having a color LCD screen to allow a user to view video files stored on the mass memory. Turning back to FIG. 3A, the PMMD 100 also includes a data input/output port 112 to enable transfer of data between the mass memory of the PMMD and an external mass memory (such as hard drive 20 of FIG. 1). The input/output port 112 is depicted here as being a universal serial buss (USB) port.

Still viewing FIG. 3A, the PMMD 100 includes at least one memory card receptacle within the housing. The memory card receptacle is configured to receive a compact moveable memory card (MC). As depicted in FIG. 3A, the PMMD includes a first MC receptacle 120 which is configured to receive a first MC of a first size, such as Memory Stick® 30A, and a second MC receptacle 122 which is configured to receive a second MC of a second size, such as SmartMedia MC 30B. The PMMD 100 can contain only a single MC receptacle, or a plurality of MC receptacles as depicted in FIG. 3A, including MC receptacles configured to receive, by way of example only, a MultiMediaCard, a Secure Digital Card, and/or a FlashCard. Preferably, each MC receptacle is provided with a spring-loaded hinged door (not shown) which closes the receptacle when no MC is placed in the receptacle to thereby prevent intrusion of dust and debris into the receptacle, but which swings open (inward to housing 102) when an MC is placed in the receptacle.

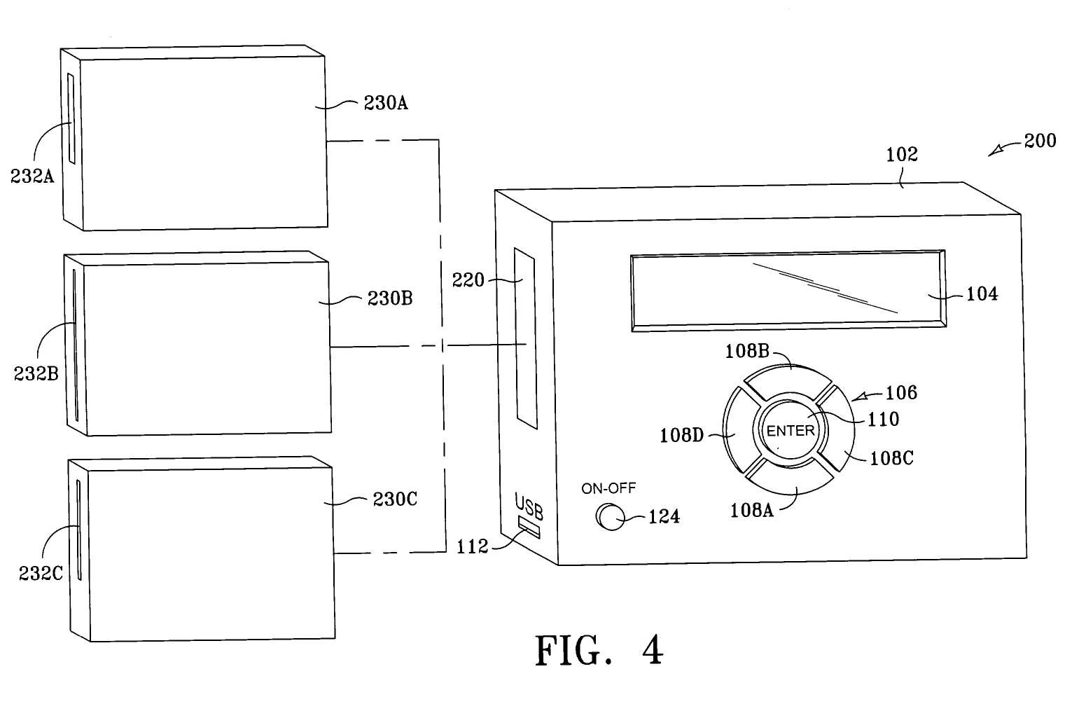

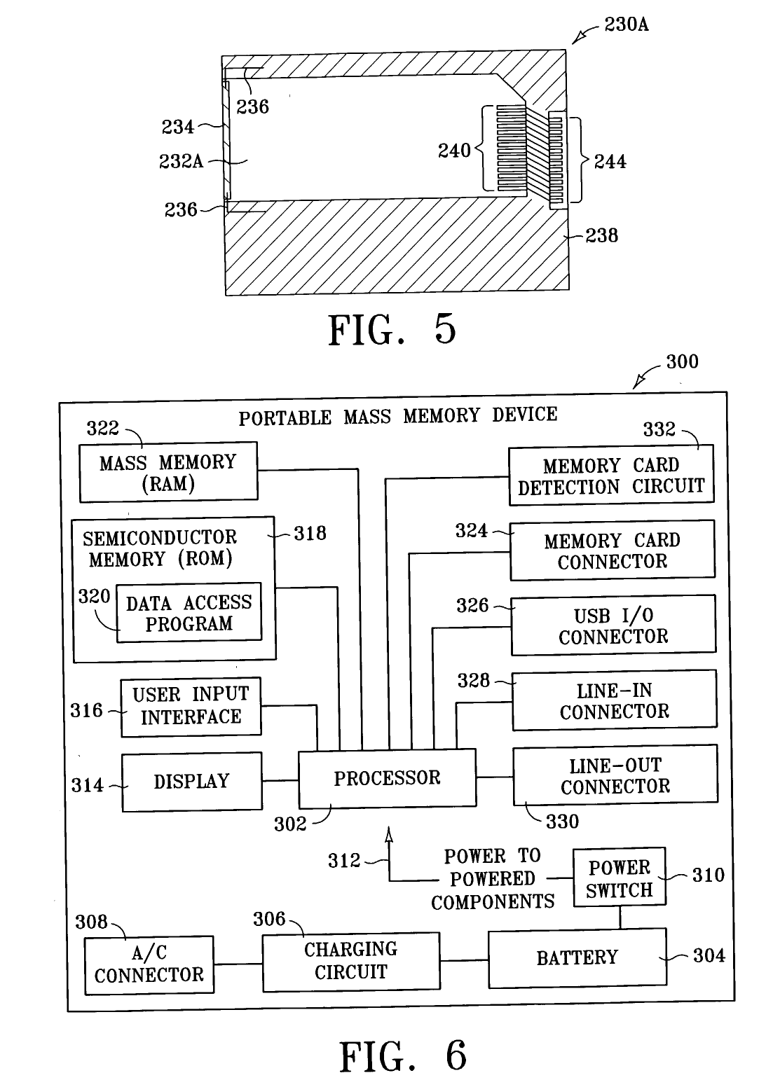

Turning now to FIG. 4, a second embodiment of a PMMD 200 in accordance with the present invention is depicted in an oblique view. The PMMD 200 can include all of the like-numbered components of the PMMD 100 of FIGS. 3A and 3B, including the user input interface 106 and the user display 104. The PMMD 200 can also include the power connector 114, the line-in jack 116, and the line-out jack 118 of the PMMD 100, all of which are not shown in FIG. 4. The primary difference between the PMMD 100 of FIG. 3A and the PMMD 200 of FIG. 4 is that the PMMD 100 has dedicated MC receptacles 120 and 122, whereas the PMMD 200 includes a universal MC receptacle 220 which is configured to receive one or more MC adapters 230A, 230B and/or 230C. That is, the PMMD 100 receives an MC directly into the MC receptacle (120 or 122), whereas the PMMD 200 receives MCs via an adapter. For example, adapter 230A is provided with MC receptacle 232A configured to receive a Memory Stick® MC, adapter 230B is provided with MC receptacle 232B configured to receive a SmartMedia MC, and adapter 230C is provided with MC receptacle 232C configured to receive a MultiMediaCard MC. FIG. 5 depicts a side elevation, sectional view of MC adapter 230A. The MC adapter 230A contains a body 238 which defines an MC receptacle 232A. A spring-loaded door 234 is supported in the body by spring hinges 236, which can be formed into an injection molded body 238. The MC adapter 230A includes a primary contact set 240 which is configured to interface with a complementary contact set on the MC, and a secondary contact set 244 which is configured to interface with a complementary contact set within the PMMD (200, FIG. 4). The contact sets 240, 244 allow data to be transferred between an MC placed in the MC receptacle 232B and the mass memory in the PMMD 200.

Preferably, rather than providing a separate MC adapter for each type of MC, a universal adapter is used, which can then be incorporated directly into the PMMD. One such universal MC adapter is described in U.S. Pat. No. 6,386,920, which is hereby incorporated herein by reference in its entirety.

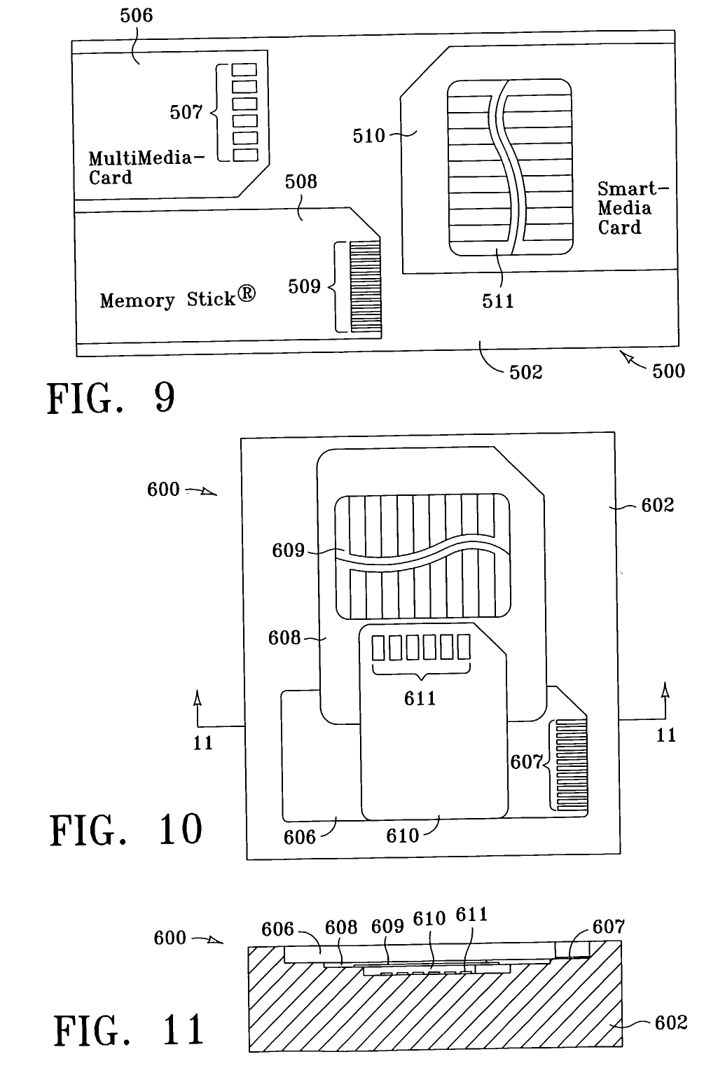

While the MC receptacles 220 (FIG. 4) and 120, 122 (FIG. 3A) are depicted as being slots formed in the housing 102 of the PMMD (100, 200), they can also be formed into the outer surface of the housing 102. Turning to FIG. 9, a rear view of a PMMD 500 in accordance with a third embodiment of the present invention is depicted. In this embodiment the PMMD 500 includes a housing 502 which has three MC receptacles formed in the outer surface of the housing. First MC receptacle 508 is exemplarily configured to receive a Memory Stick® MC, and housing 502 supports in receptacle 508 a first MC contact set 509 configured to interface with a respective contact set of a Memory Stick® MC. Similarly, MC receptacle 510 is configured to receive a SmartMedia MC, and has a second contact set 511 configured to interface with a respective contact set of a SmartMedia MC. Likewise, MC receptacle 506 is configured to receive a MultiMediaCard MC, and has a third contact set 507 configured to interface with a respective contact set of a MultiMediaCard MC. Each of the MC contact sets 507, 509 and 511 allow data transfer between an MC placed in a respective MC receptacle 506, 508 and/or 510 and the mass memory (not shown) supported within the housing 502. MC receptacles 506, 508 and 510 can be covered with one or more removable or hingedly attached covers (not shown). Further, rather than configuring the receptacles 506, 508 and 510 to directly receive the MCs, the removable cover(s) can be configured to receive the MCs, such that when the removable cover is placed over the receptacle area(s) 506, 508 and/or 510, the contact set on the MC(s) will be placed in signal contact with a corresponding contact set (507, 509, and/or 511) supported by the housing 502.

As an alternative to providing separate receptacles 506, 508 and 510 for each type of MC to be received by the PMMD 500, a universal receptacle can be configured into the housing of the PMMD. As is apparent by viewing the three MCs depicted in FIGS. 1A through 1C, the difficulty in configuring a universal receptacle is that each contact set (36A, 36B and 36C) of each MC is different than the other contact sets, and does not allow for generally overlaying MCs into a common area. One solution is depicted in FIG. 10. FIG. 10 depicts a rear view of a PMMD 600 having a series of layered MC receptacles 606, 608 and 610 formed in the housing 602. FIG. 11 depicts a side elevation, sectional view of the PMMD 600 of FIG. 10. As can be seen, receptacle 610, which can accommodate a MultiMediaCard MC, is set lowest in the housing. Housing 602 supports contact set 611 in the receptacle 610. Above MC receptacle 610, receptacle 608 is configured to support a SmartMedia MC, and contact set 609 is supported by the housing 602 to allow a SmartMedia MC placed in receptacle 608 to interface with the PMMD 600. Finally, near the outer surface of housing 602, a receptacle 606 is provided, which can support a Memory Stick® MC. Contact set 607 is supported in receptacle 606. A series of spring levers (not shown) can be provided to urge an MC out of the receptacle in which it is placed. Further, each receptacle can be provided with a graphical representation of the type of MC which is configured to be received within the receptacle to facilitate correct user placement of an MC into the proper receptacle.

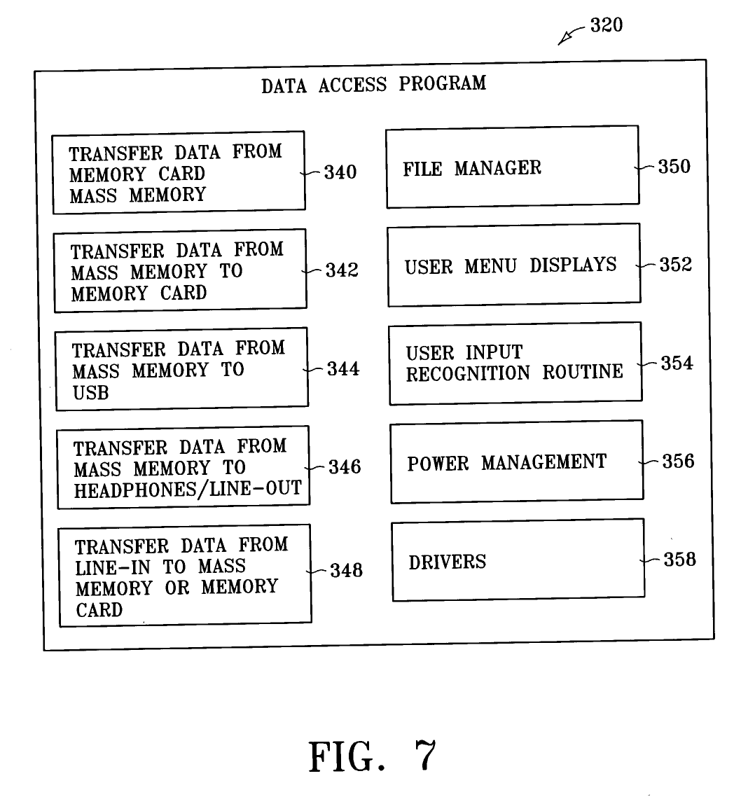

Turning now to FIG. 6, a schematic diagram depicts various components of a PMMD in accordance with the present invention. The exemplary PMMD 300 of FIG. 6 includes a mass memory 322 which is supported within a housing (such as housing 102 of FIG. 3A). The mass memory 322 is a random access memory (RAM) device, such as a hard disk drive. The PMMD further includes a memory card connector 324, which is located in the MC receptacle (e.g., 120,122 of FIG. 3A). The MC connector 324 includes a contact set (such as contact set 509 of FIG. 9) to allow a complementary contact set on an MC to establish data communication between the MC and the PMMD 300. The MC connector 324 can also be configured to mate with an MC adapter contact set, such as contact set 244 shown with MC adapter 230B of FIG. 5. The PMMD 300 also includes a processor 302, and a data access program 320. The data access program 320 is executable by the processor and configured to enable transfer of digital data from an MC placed in the MC receptacle (and thus in contact with the MC connector 324) to the mass memory 322. The data access program 320 can be contained in a semiconductor memory device, such as the read-only-memory (ROM) device 318, but can also (and less preferably) be stored on the mass memory 322. Alternately, the semiconductor memory 318 can be a RAM-type memory to allow updates to the data access program 320.

Preferably, the PMMD 300 also includes a user input interface 316 (such as user input interface 106 of FIG. 3A). The user input interface 316 is configured to enable a user to cause the processor 302 to execute the data access program 320 and thereby effect transfer of digital data from an MC in contact with the MC connector 324 to the mass memory 322. A user display 314 (e.g., display 104 of FIG. 3A) can also be provided to facilitate the user in transferring data via the user input interface 316, as will be more fully described below. The user input interface 316 can also be combined with the display 314 in the form of a touch-screen, as described more fully below. The PMMD 300 is provided with an input/output port, such as USB connector 326, which is in signal communication with the processor 302 to thereby enable transfer of data from the mass memory 322 to an external mass memory (such as hard drive memory 20 in computer 10 of FIG. 1). The input/output port 326 can also be used to enable transfer of data to the mass memory 322 from an external mass memory.

Preferably, the PMMD 300 includes a self-contained power source, such as battery 304, configured to provide electrical power to the processor 302, the mass memory 322, and any other components requiring power in the PMMD. The battery 304 can be connected to a charging circuit 306, which is in turn connected to an a/c electrical connector 308 (shown as a/c power connector 114 in the PMMD 10 of FIG. 3B), to thereby allow the battery 304 to be charged from an external power source. The charging circuit 306 can also include a transformer component (not shown) to convert a/c power from the connector 308 into d/c power, so that the PMMD 300 can be powered directly from an external a/c power supply. Battery 304 is further connected to power switch 310 (similar to power switch 124 in FIG. 3A), which enables electrical power to be provided to power-driven components of the PMMD 300 via a power distribution circuit 312.

The PMMD 300 can optionally be provided with a line-in connector 328 (described above with respect to line-in connector 116 of FIG. 3B), and a line-out connector 330 (described above with respect to headphone connector 118 of FIG. 3B). Further, the PMMD 300 can be provided with an MC detection circuit 332. The MC detection circuit 332 can be activated by a switch (not shown) which is operated when an MC (or an MC adapter) is connected to the MC connector 324. The MC detection circuit can then enable execution of the data access program 320 via the processor 302, and cause a preselected display to appear in the user display 314. For example, when an MC is connected to MC connector 324, then the MC detection circuit 332 can cause the data access program 320 to generate a message on the user display 314 which says, “Transfer data to/from memory card?” If the user desires to perform either of these functions, the user can push the “Enter” button (button 110 in FIG. 3A) on the user input interface 106.

Turning now to FIG. 7, an exemplary data access program 320 (corresponding to data access program 320 of FIG. 6) is depicted in a schematic block diagram. The data access program 320 is configured to allow a user to transfer data between an MC and the mass memory (322, FIG. 6). The data access program can include the following routines: (1) Routine 340 allows a user to transfer data from an MC, placed in an MC receptacle in the PMMD, to the mass memory 322 (FIG. 6). (2) Routine 342 allows a user to transfer data from the mass memory 322 (FIG. 6) to an MC which is placed in an MC receptacle in the PMMD. (3) Routine 344 allows a user to transfer data from the mass memory (322, FIG. 6) in the PMMD to an external mass memory (e.g., hard drive memory 20 in computer 10 of FIG. 1) via the input-output port (I/O connector 324, FIG. 6). (4) Routine 346 allows a user to transfer data (in “real-time” from the mass memory (332, FIG. 6) to a line-out connection, such as line-out connector 330 of FIG. 6. An example of the use of routine 346 is to play an MP3 music file which can be listened to by a user using a set of headphones and the headphone jack 118 of FIG. 3B. (5) Routine 348 allows a user to transfer data (in “real-time”) via a line-in jack (328, FIG. 6, and/or 116, FIG. 3A), and record the data on the mass memory 322 (FIG. 6), and/or an MC placed in the MC receptacle (receptacle 120 of FIG. 3A, or MC connector 324 of FIG. 6).

The data access program 320 of FIG. 7 can also include a “file manager” routine 350, which can be used to allow a user to effect selective (versus global) transfer of files between the mass memory (322, FIG. 6) and an MC placed in the MC receptacle (receptacle 120 of FIG. 3A, or MC connector 324 of FIG. 6). The file manager routine 350 can also be used to allow a user to selectively delete files on the mass memory 322 and/or an MC in the MC receptacle. The file manager routine 350 can also be configured to allow a user to relocate (or move) a file on the mass memory and/or an MC from a first address to a second address. For example, when the PMMD is connected to a computer (such as computer 10 of FIG. 1), the user can configure the mass memory into directories, subdirectories and folders. The file manager can thus allow files to be moved between these directories, subdirectories and folders.

Routine 352 of FIG. 7 is a file containing user menu displays, which can be displayed to a user via a user display (display 314 of FIG. 6, and 104 of FIG. 3A). An example of the types of user displays that can be presented is described more fully below. The data access program 320 can also include a user input recognition routine 354, which works in conjunction with the user input interface (106, FIG. 3A, 316, FIG. 6) to recognize user inputs, as will be described more fully below. Routine 356 is a power management routine, and can work in conjunction with the charging circuit 306, and battery 304, of FIG. 6 to monitor and control charging of the battery, notification to the user (via the user display 316) of the charge state of the battery, and also to disable certain functionality of the PMMD in the event of a low battery condition. For example, the power management routine 356 can disable data transfer between the mass memory 322 (FIG. 6) and an MC in the event of a low battery power condition, to thus avoid a write-error to the mass memory in the event of power failure during any such data transfer. Routine 358 includes the drivers which provide data transfer protocols for the data transfer routines 340, 342 and 344 to enable data transfer between various formats of MCs and mass memory devices. The drivers 358 can also be stored on the mass memory (322, FIG. 6) so that they can be updated if new or different MC formats are to be accommodated.

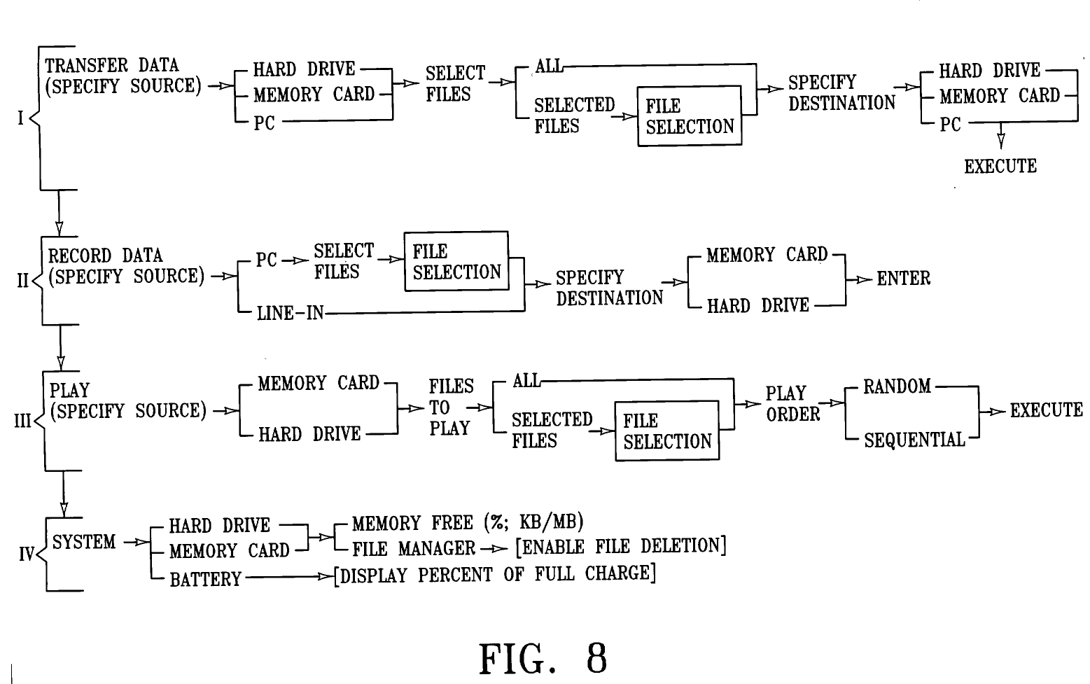

Turning now to FIG. 8, a schematic diagram of an exemplary user menu map 400 is provided. The user menu map 400 shows some of the menu selections that can be offered to a user by the user menu displays routine (352, FIG. 7) via the user display (314, FIG. 6, 104, FIG. 3A). When selected ones of the user menu selections depicted in FIG. 8 are displayed, a user can invoke the offered functionality by pressing the “Enter” button 110 of the user input interface 106 of FIG. 3A. The user can also use the menu navigation buttons 108A-108D of FIG. 3A to move from menu-selection to menu-selection, as will be described more fully below. The menu map 400 can be properly described as a “hierarchical menu”, since it allows a user to navigate through hierarchies of menu selections.

FIG. 8 depicts the menu map 400 as offering the user four main menu options, indicated as options I-IV. More or less main menu options can be provided. The following description will assume, for purposes of discussion only, that the menu map is as shown in FIG. 8. A user can initiate menu selection by pressing any of the keys in the user input interface 106 of FIG. 3A. The first display that will be presented to the user via the display 104 (FIG. 3A) is “Transfer data (specify source)”. If the user does not want to perform this function, then the user presses the “down” navigation button 108A to move downward in the menu map to the next menu selection, selection II, “Record data (specify source)”. Pressing the “down” button 108A again moves the user to menu selection III, and pressing it again moves the user to menu selection IV. By pressing the “up” menu navigation button 108B, the user can move sequentially back upwards through the main menu selections I-IV. Once a user has arrived at a main menu selection (I-IV) that the user wishes to invoke, then the user can press the “Enter” button 110, or merely press the “right navigation” button 108C to move to the next lower hierarchical level in the menu. For example, if at level I the user desires to transfer data, then by pressing button 108C the first selection of “hard drive” (as the data source) will be displayed on the display 104. Then, by sequentially pressing the “down” navigation button 108A, the next two data source options (“memory card” and “PC” (personal computer)) will be sequentially displayed. Pressing the “down” button 108A again will cause the menu selection to be repeated, thus displaying “hard drive”. Once the user has selected the data source, by pressing “Enter” (110) or the right-navigation button (108C), the user will be prompted with “Select Files”. Pressing “Enter” (110) or right-navigation (108C) will display the first option in the next hierarchical level in the menu, being “All” (for “all files”). If the user presses the “down” navigation button 108A, the option of “selected files” will be displayed in display 104, and the user will then be able to use a “file selection” sub-menu to select files. The file selection sub-menu can be configured to allow a user to surf to a directory, sub-directory, and/or a folder, and select the directory, sub-directory, folder, or selected files in the folder, for transfer. By pressing “Enter” (110) twice after selecting the files to be transferred, the user is then presented with “specify destination” (i.e., where the files are to be transferred to). Again, a scroll-down type menu is presented, with “hard drive” as the first selection. Once the file destination has been selected by the user, the user is prompted to press “Enter” to effect the file transfer.

If at any time during the selection process the user wishes to return to return to the previous hierarchical level in the menu (i.e., an earlier menu option), then the user can use the “left-navigation” button 108D For example, if at level I the user has proceeded to the “select files” option for transfer of files, and realizes that the previously selected source (e.g., “hard drive”) should instead be a different source, then by pressing button 108D the user can return to the source selection menu and select a different source. Repeated pressings of the left-navigation button 108D will sequentially move the user back through the menu selection options for the given main menu level. Menu level 11 is configured to allow a user to record data (specifically, in real-time form) on one of the selected memory devices (the mass memory 322 of FIG. 6, or an MC such as MC 30A of FIG. 3A). Menu level III is configured to allow a user to play recorded data (specifically, in real-time form) on one of the selected memory devices (the mass memory 322 of FIG. 6, or an MC such as MC 30A of FIG. 3A). For example, menu level III can be used to allow a user to play an MP3 music file. Menu level IV is a “system” menu, and allows a user to acquire information relating to the status of the PMMD (e.g., free memory space in the mass memory and/or an MC connected to the PMMD, and battery charge level). The “system” menu IV can also be configured to allow a user to delete files, either selectively or globally, from the mass memory and/or an MC connected to the PMMD.

It will be appreciated that various alternative logic arrangements, beyond those shown and described above with respect to FIG. 8, can be used to implement a menu map which is to presented to a user. If display 104 (FIG. 3A) is sufficiently large to allow multiple lines of text to be displayed, then the menu selection process can take advantage of this feature to reduce keystrokes required for a user to make a menu selection. Further, a user input interface can be incorporated into a user display in the form of a touch-screen (common on many personal digital assistants currently available). In touch-screen operation, the user uses a stylus (or, less preferably, a finger) to touch the screen at a point where a graphical image or text is displayed which represents the users menu choice.

In an alternate, but less preferable, embodiment of the present invention, a PMMD can be provided that does not have an MC receptacle (such as MC receptacle 120 of FIG. 3A), but does include a data access program (such as program 320 of FIG. 6) executable by the processor (302, FIG. 6). In this embodiment, an MC can be placed in an MC reader, such as MC reader 26 of FIG. 1, and the MC reader can then be connected to an input-output port, such as USB I/O connector 326 of FIG. 6. In this embodiment the data access program is configured to enable transfer of digital data from a compact moveable memory card placed in the MC reader to the mass memory (322, FIG. 6).

It will be appreciated that the schematic diagram of components of the PMMD 300 of FIG. 6, the schematic diagram of components of the data access program 320 of FIG. 7, and the schematic diagram of the menu map 400 of FIG. 8, are exemplary only. Other PMMD components, data access program components, and menu map components can be added to the respective PMMD 300, data management program 320, and menu map 400, and selected components can be deleted therefrom, all within the spirit of the present invention.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A portable mass memory device, comprising:
a housing;
a mass memory supported within the housing;
a memory card receptacle within the housing, the memory card receptacle configured to receive a compact moveable memory card;
a processor; and
a data access program executable by the processor and configured to enable transfer of data from a compact moveable memory card placed in the memory card receptacle to the mass memory.

2. The portable mass memory device of claim 1, and further comprising a user input interface configured to enable a user to cause the processor to execute the data access program and thereby effect transfer of data from the compact moveable memory card to the mass memory.

3. The portable mass memory device of claim 2, and further comprising an input/output port in signal communication with the processor to enable transfer of data from the mass memory to an external mass memory.

4. The portable mass memory device of claim 1, and further comprising a semiconductor memory device in communication with the processor, and wherein the data access program is stored in the semiconductor memory device.

5. The portable mass memory device of claim 2, and further comprising a user display in communication with the processor.

6. The portable mass memory device of claim 1, and wherein the device is not enabled to allow data stored in the mass memory to be edited other than selective arrangement and deletion of data from the mass memory.

7. The portable mass memory device of claim 1, and wherein the mass memory is a hard disk drive.

8. The portable mass memory device of claim 1, and further comprising a self-contained power source configured to provide electrical power to the processor and the mass memory.

9. The portable mass memory device of claim 1, and wherein the data access program is further configured to enable transfer of data from the mass memory to a compact moveable memory card placed in the memory card receptacle.

10. The portable mass memory device of claim 9, and further comprising a user input interface configured to enable a user to cause the processor to execute the data access program and thereby effect transfer of data between the compact moveable memory card and the mass memory.

11. The portable mass memory device of claim 10, and wherein the user input interface is a touch-screen.

12. The portable mass memory device of claim 10, and wherein the data access program is further configured to receive inputs from the user input interface to allow a user to effect selective transfer of data between the compact moveable memory card and the mass memory.

13. The portable mass memory device of claim 1, and wherein the memory card receptacle is a first memory card receptacle configured to receive a first compact moveable memory card of a first size, the device further comprising a second memory card receptacle within the housing, the second memory card receptacle configured to receive a second compact moveable memory card of a second size.

14. The portable mass memory device of claim 1, and wherein the memory card receptacle is configured to receive the compact moveable memory card via a memory card adapter.

15. A portable hard disk drive, comprising:
a housing;
a hard disk drive supported within the housing;
a memory card receptacle within the housing, the memory card receptacle configured to receive a compact moveable memory card;
a processor; and
a data access program executable by the processor, and wherein the data access program enables transfer of data from a compact moveable memory card placed in the memory card receptacle to the hard disk drive.

16. The portable hard disk drive of claim 15, and further comprising a user input interface enabling a user to cause the processor to execute the data access program and thereby effect transfer of data from the compact moveable memory card to the hard disk drive.

17. The portable hard disk drive of claim 16, and wherein the data access program further enables selective transfer of data between a compact moveable memory card placed in the memory card receptacle and the hard disk drive, and selective deletion of data from the hard disk drive and a compact moveable memory card placed in the memory card receptacle.

18. A portable mass memory device, comprising:
a housing;
a mass memory supported within the housing;
a plurality of first memory card contact sets supported by the housing, each memory card contact set configured to interface with a respective second contact set of a corresponding compact moveable memory card;
a processor; and
a data access program executable by the processor to thereby enable the transfer of data from a compact moveable memory card placed in contact with at least one of the first memory card contact sets to the mass memory.

19. The portable mass memory device of claim 18, and wherein the housing defines a plurality of receptacles each configured to receive a compact moveable memory card having the second memory card contact set, to thereby allow the second memory card contact set to be placed in contact with a corresponding first memory card contact set supported by the housing.

20. The portable mass memory device of claim 18, and further comprising a movable cover supportable by the housing, the movable cover configured to receive a plurality of compact moveable memory cards each having the second memory card contact set, and, when the movable cover is supported by the housing in proximity to the first memory card contact sets, to thereby allow the second memory card contact sets to be placed in contact with corresponding first memory card contact sets supported by the housing.

21. The portable mass memory device of claim 18, and wherein the housing defines a universal receptacle configured to receive at least two compact moveable memory cards of different shapes, each compact moveable memory card having the second memory card contact set, to thereby allow the second memory card contact sets to be placed in contact with corresponding first memory card contact sets supported by the housing.

22. A portable mass memory device, comprising:
a housing;
a mass memory supported within the housing;
an input/output port supported by the housing and in signal communication with the processor, and connectable to a compact moveable memory card reader configured to receive a compact moveable memory card, to thereby enable transfer of data from a compact moveable memory card placed in the compact moveable memory card reader to the mass memory;
a processor; and
a data access program executable by the processor and configured to enable transfer of data from a compact moveable memory card placed in the compact moveable memory card reader to the mass memory.
